(19) United States
(12) Patent Application Publication
(10) Pub. No.: US 2014/0306865 A1
(43) Pub. Date: Oct. 16, 2014

(54) METHOD FOR COMMUNICATING WITH A PLURALITY OF FIRST DISPLAY DEVICES AND AT LEAST ONE SECOND DISPLAY DEVICE, AND ELECTRONIC APPARATUS USING THE SAME METHOD

(71) Applicant: SHANGHAI POWERMO INFORMATION TECH. CO. LTD., Shanghai (CN)

(72) Inventors: Qi Pan, Shanghai (CN); Wei Zhu, Shanghai (CN)

(73) Assignee: Shanghai PowerMo Information Tech. Co. Ltd., Shanghai (CN)

(21) Appl. No.: 13/866,033

(22) Filed: Apr. 19, 2013

(30) Foreign Application Priority Data
Apr. 12, 2013 (CN) 201310127915.4

(51) Int. Cl. G06F 3/14

(52) U.S. Cl. CPC G06F 3/1423
USPC 345/2.1

(57) ABSTRACT

An electronic apparatus capable of communicating with first display devices and second display device to allow establishing M:N source devices to sink devices content composition. It include a transceiver module, a layout manager, a compositor, a mixer, and a human-machine-interactivity mapper. Transceiver module is arranged for communicating with first display devices and receiving contents from first display devices, it is also arranged for communicating with second display device and transmitting a combined image to the second display device. Layout manager is arranged for maintaining layout information of second display device so as to generate a layout policy. Compositor is arranged for composing images of contents so as to generate combined image according to layout policy. Mixer is arranged for mixing audio streams of contents so as to generate a mixed audio stream according to audio mixing policy. The human-machine-interactivity mapper is arranged for allowing user interaction from connected console device.

### BACKGROUND OF THE INVENTION

1. Field of the Invention

The present invention relates to user interactions between a system containing multiple display devices, and more particularly, to a method for communicating with a plurality of first display devices and at least one second display device and an electronic apparatus using the same method.

2. Description of the Prior Art

These days a system containing multiple display devices becomes popular, and physical connections between those display devices can be a wired cable (such as, HDMI and MHL) or wireless (such as, Wi-Di and Miracast etc. Wi-Fi display technology). It's expected that rich user interactions can invoke usages allowing more than two devices in one multiple-display system to work with each other. For example, a multiple-display system contains a plurality of mobile devices (first display devices, can serve as source devices) plus at least one of HDTV (second display device, can serve as sink device), wherein all of the mobile devices can render their contents to the at least one of HDTV and allow users to operate in the second display device simultaneously.

Hence, how to extend the 1-to-1 connected usage scenario to M-to-N connected usage scenario so as to provide convenience to users has become an important topic in this field.

### SUMMARY OF THE INVENTION

It is therefore one of the objectives of the present invention to provide a method for communicating with a plurality of first display devices and at least one second display device and an electronic apparatus using the same method to solve the above-mentioned problems in the prior art.

According to one aspect of the present invention, a method for communicating an electronic apparatus with a plurality of first display devices and at least one second display device, applied to an electronic device is provided. The method includes the following steps: communicating with the plurality of first display devices and receiving a plurality of contents from the plurality of first display devices; maintaining layout information of the at least one second display device so as to generate a layout policy; composing images of the plurality of contents received from the plurality of first display devices so as to generate a combined image according to the layout policy; and communicating with the at least one second display device and transmitting the combined image to the at least one second display device.

According to another aspect of the present invention, an electronic apparatus capable of communicating with a plurality of first display devices and at least one second display device is provided. The electronic apparatus may include a transceiver module, a layout manager, and a compositor. The transceiver module is arranged for communicating with the plurality of first display devices and receiving a plurality of contents from the plurality of first display devices. The layout manager is arranged for maintaining layout information of the at least one second display device so as to generate a layout policy. The compositor is arranged for composing images of the plurality of contents received from the plurality of first display devices so as to generate a combined image according to the layout policy. The transceiver module is further arranged for communicating with the at least one second display device and transmitting the combined image to the at least one second display device.

By adopting the method for communicating with a plurality of first display devices (can serve as source device) and at least one second display device (can serve as sink device) and an electronic apparatus using the same method of the present invention, the goal of M-to-N connected usage scenario can be achieved, which can provide more convenience to users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a multiple-display system allowing an electronic apparatus to communicate with a plurality of first display devices and at least one second display device according to an embodiment of the present invention.

FIG. 2 is a block diagram illustrating an electronic apparatus capable of communicating with a plurality of first display devices and at least one second display device according to a first embodiment of the present invention.

FIG. 3 is a block diagram illustrating an electronic apparatus capable of communicating with a plurality of first display devices and at least one second display device according to a second embodiment of the present invention.

FIG. 4A is a block diagram illustrating an electronic apparatus capable of communicating with a plurality of first display devices and at least one second display device according to a third embodiment of the present invention.

FIG. 4B is a diagram illustrating an example that in the console device, user launches the application which displays the whole layout UI relevant to the second display device and user operates in the console application to control both applications.

FIG. 4C is a diagram illustrating another example that in the console device, user launches the application which displays one of the selected application layout UI relevant to the second display device and user operates in the console application to control only that selected application.

FIG. 5A is a flowchart illustrating how user input events are caught in the console device side, normalized, and transferred to the device in which the operated application runs.

FIG. 5B is a flowchart illustrating how the normalized user input events are restored and injected to real application execution environment to be processed.

FIG. 6 is a diagram showing a multiple-display system for implementing a “Share Desk” implementation, which is a touchable desk shared by a small group of students according to another usage scenario of the present invention.

FIG. 7 (including sub-diagrams 7A and 7B) is a diagram illustrating a condition that how the electronic apparatus acted like if the dongle able to support only one second display device according to a first embodiment of the present invention.

FIG. 8 (including sub-diagrams 8A and 8B) is a diagram illustrating another condition that how the electronic apparatus acted like if the dongle able to support multiple second display devices according to a second embodiment of the present invention.

FIG. 9 is a flowchart illustrating a method, applied to an electronic device, for communicating an electronic apparatus with a plurality of first display devices and at least one second display device according to an exemplary embodiment of the present invention.

FIG. 10 is a flowchart illustrating a method, applied to an electronic device, for communicating an electronic apparatus with a plurality of first display devices and at least one second display device according to another exemplary embodiment of the present invention.

FIG. 11 is a flowchart illustrating a method, applied to an electronic device, for communicating an electronic apparatus with a plurality of first display devices and at least one second display device according to still another exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

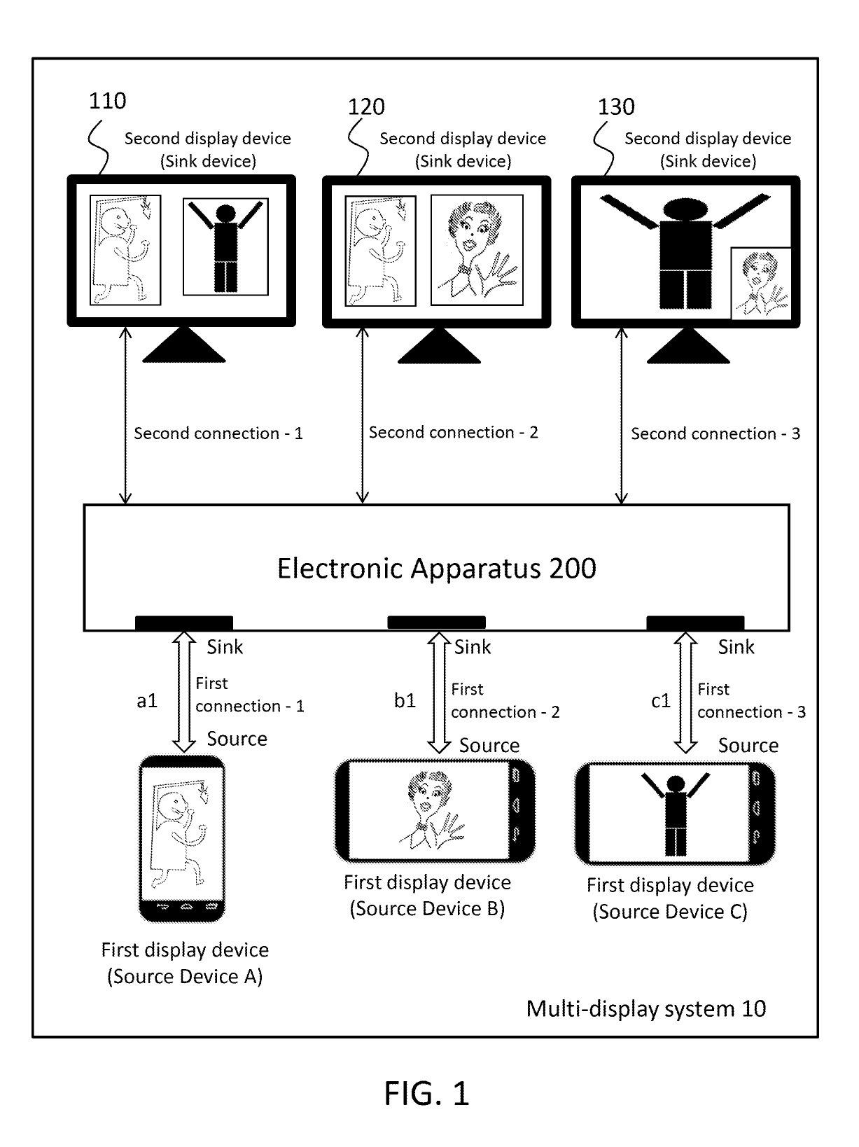

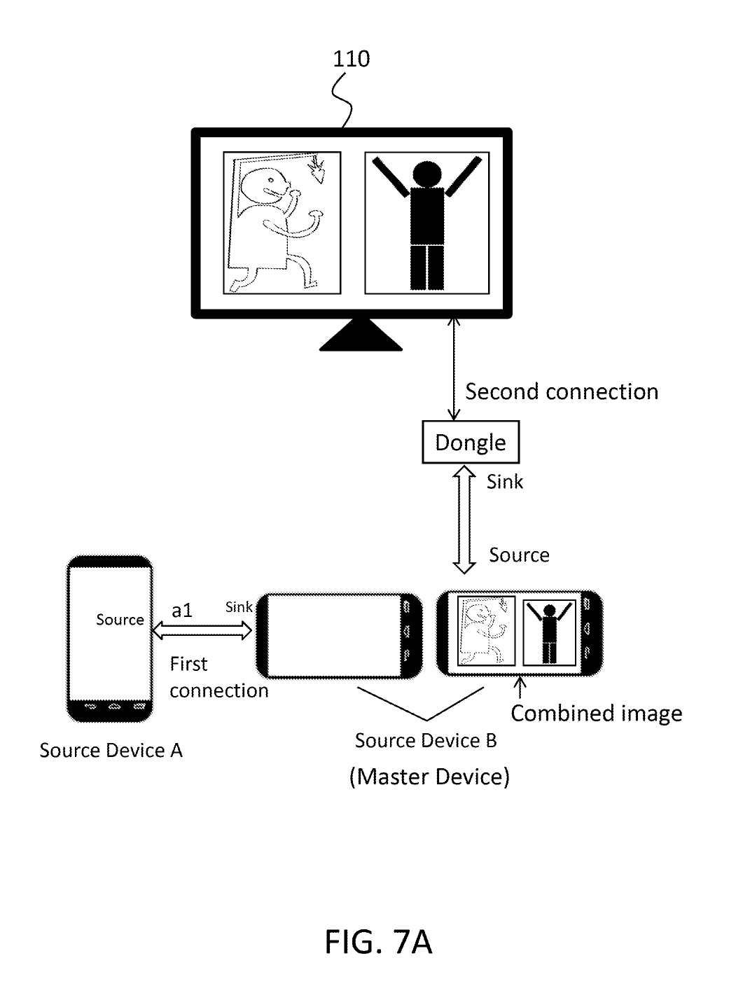

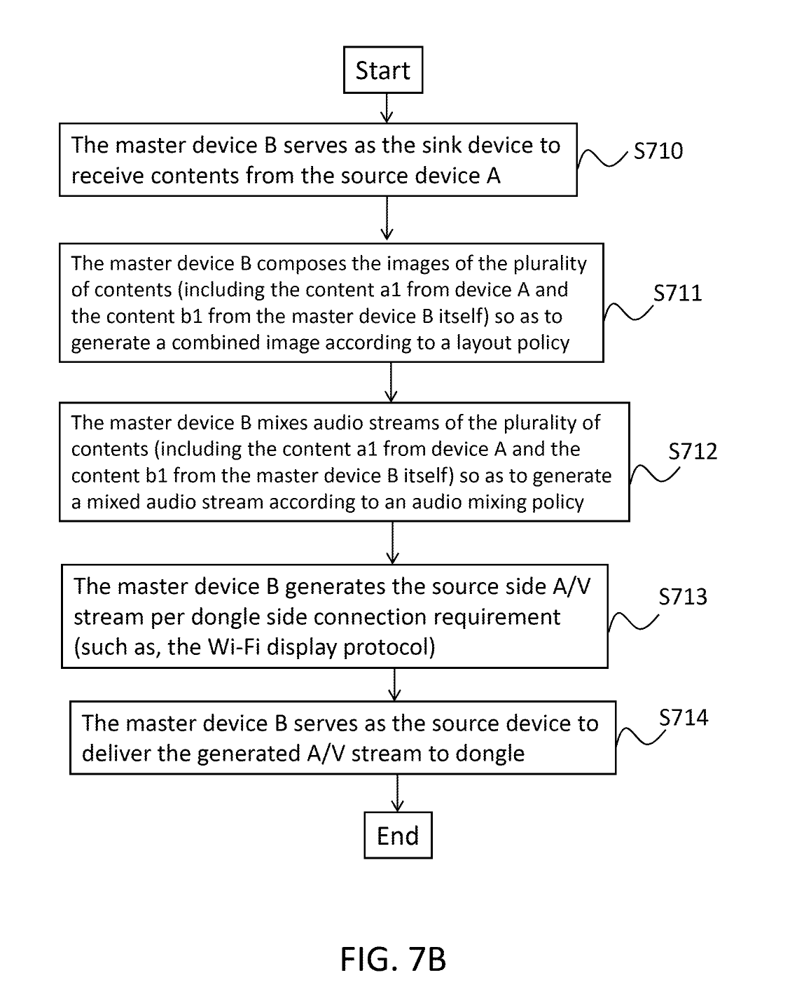

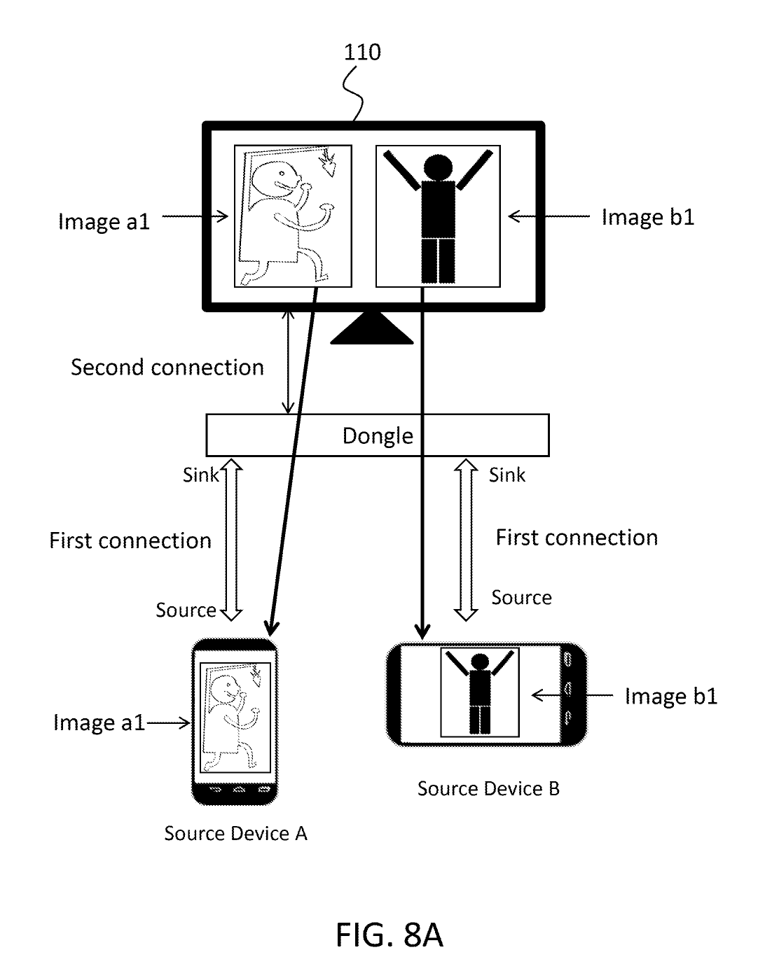

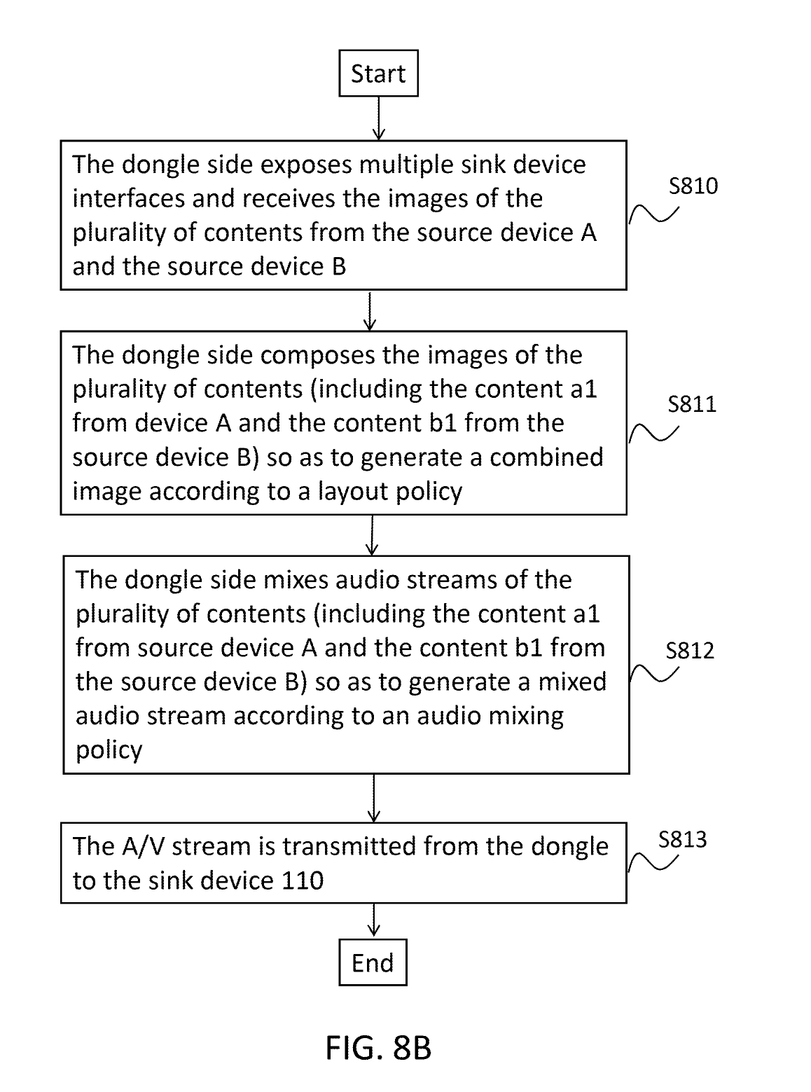

Please refer to FIG. 1. FIG. 1 is a diagram showing a multiple-display system 10 allowing an electronic apparatus 200 to communicate with a plurality of first display devices (including first display devices A, B, and C, can serve as source devices in this embodiment) and at least one second display device (including second display devices 110, 120, and 130, can serve as sink devices in this embodiment) according to an embodiment of the present invention. The electronic apparatus 200 here is a virtual device and it can have multiple physical incarnations—like in FIG. 7, it includes a dongle that supports only one second display device connection and one master device; and in FIG. 8, it includes a dongle that supports multiple second display devices connections. Moreover, the electronic apparatus 200 may also include the first display device and second display devices or even other devices (such as serving as console device) to complete certain features like interacting with the application runs in source side, modifying the layout policy. In this embodiment, a plurality of first display devices A, B, and C are capable of connecting to a plurality of second display devices 110, 120, and 130, simultaneously. However, the number of the first display devices and the number of the second display devices should not be a limitation of the present invention. As shown in FIG. 1, the first display devices A, B, and C are casting streaming contents a1, b2, and c1 to various second display devices, respectively. For example, the first display device A is casting the streaming content “a1” to the second display devices 110 and 120, the first display device B is casting the streaming content“b1” to the second display devices 120 and 130, and the first display device C is casting the streaming content “c1” to the second display devices 110 and 130. By using the electronic apparatus 200, the casted streaming contents are well re-laid out and composed to be delivered to various second display devices in various desired formations of layout and effects.

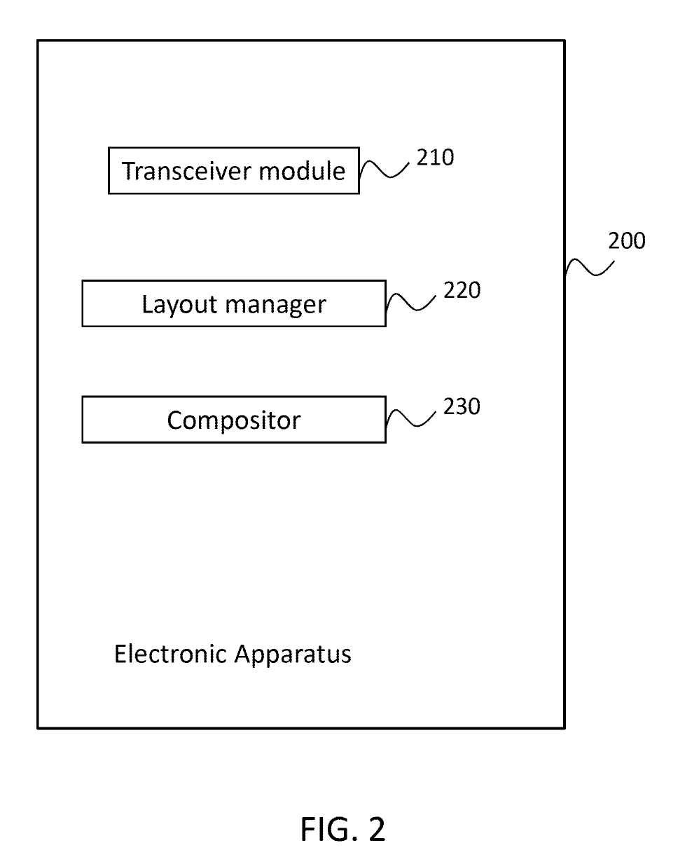

Please refer to FIG. 2 together with FIG. 1. FIG. 2 is a block diagram illustrating an electronic apparatus 200 capable of communicating with a plurality of first display devices and at least one second display device according to a first embodiment of the present invention. In this embodiment, the electronic apparatus 200 may include a transceiver module 210, a layout manager 220, and a compositor 230. The transceiver module 210 is arranged for communicating with the plurality of first display devices (such as, first display devices A, B, and C) and receiving a plurality of contents (such as streaming contents a1, b1, and c1) from the plurality of first display devices. The layout manager 220 is arranged for maintaining layout information of the at least one second display device (such as, the second display devices 110, 120, and 130) so as to generate a layout policy. The compositor 230 is arranged for composing images of the plurality of contents (such as, streaming contents a1, b1, and c1) received from the plurality of first display devices so as to generate a combined image according to the layout policy. The transceiver module 210 is further arranged for communicating with the at least one second display device (such as the second display devices 110, 120, and 130) and transmitting the combined image to the at least one second display device.

Please note that: the plurality of contents (such as, streaming contents a1, b1, and c1) from the plurality of first display devices A, B, and C may include portrait mode images and/or landscape mode images. For example, as shown in FIG. 1, the streaming content a1 from the first display device A is a portrait mode image, the streaming content b1 from the first display device B is a landscape mode image, and the streaming content c1 from the first display device C is a landscape mode image. That is to say, either portrait mode images and/or landscape mode images from the first display devices can be suitable in the electronic apparatus and the method disclosed in the present invention.

Please note that, in one embodiment, one first connection (also see FIG. 7A) is built between one of the plurality of first display devices (such as, first display devices A) and another first display device (such as device B in FIG. 7A) and another first connection is built between the master device (such as device B in FIG. 7A) and the dongle. In another embodiment, a plurality of first connections (also see FIG. 8A) are built between the transceiver module 210 and the plurality of first display devices (such as, first display devices A, B, and C). Each of the first connection(s) can be a HDMI cable, a MHL cable, a Miracast connection, a Wi-Di connection, or a Wi-Mo connection etc. Wi-Fi display connections; however, this should not be a limitation of the present invention.

Please also note that, a second connection (not shown) is built between the transceiver module 210 and the at least one second display device (such as, second display devices 110, 120, and 130).The second connection can be a HDMI cable, a MHL cable, a Miracast connection, a Wi-Di connection, or a Wi-Mo connection etc. Wi-Fi display connections. And if the HDTV itself can implement abovementioned features of module 210, there is no such second connection required at all.

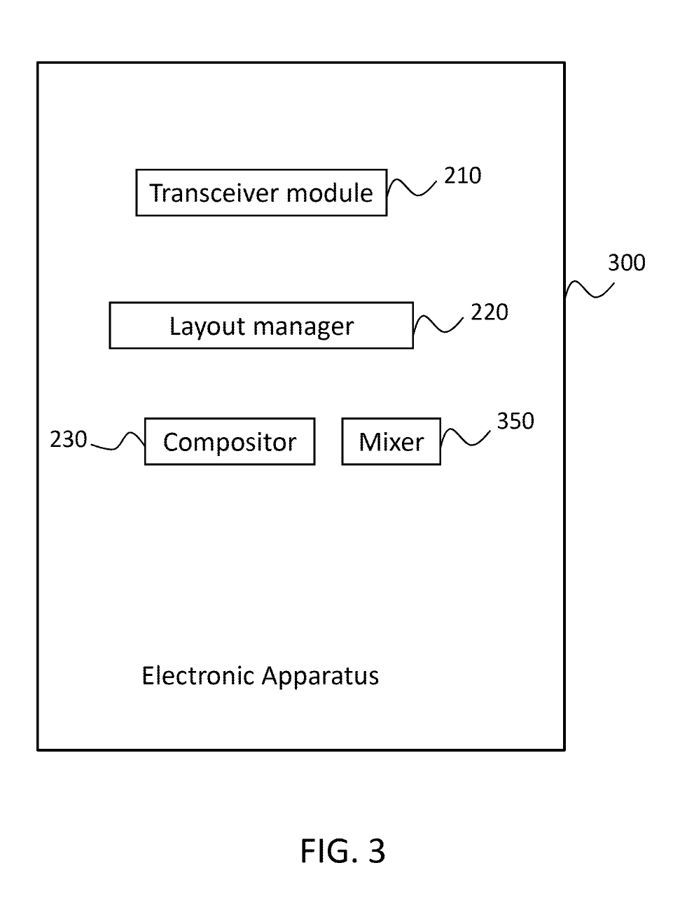

Please refer to FIG. 3 together with FIG. 1 and FIG. 2. FIG. 3 is a block diagram illustrating an electronic apparatus 300 capable of communicating with a plurality of first display devices and at least one second display device according to a second embodiment of the present invention. The electronic apparatus 300 shown in FIG. 3 is similar to the electronic apparatus 200 shown in FIG. 2, and the difference between them is that: the electronic apparatus 300 further includes a mixer 350 for mixing audio streams of the plurality of contents (such as, the streaming contents a1, b1, and c1) received from the plurality of first display devices (such as, the first display devices A, B, and C) so as to generate a mixed audio stream according to an audio mixing policy. In this embodiment, the transceiver module 210 is further arranged for transmitting the mixed audio stream to the at least one second display device (such as, the second display devices 110, 120, and 130). In other words, only the images of the plurality of contents a1, b1, and c1 from the plurality of first display devices A, B, and C are composed so as to generate the combined image in the embodiment of FIG. 2, however, the images and the audio streams of the plurality of contents a1, b1, and c1 from the plurality of first display devices A, B, and C are composed and mixed so as to generate the combined image and the mixed audio stream in the embodiment of FIG. 3.

In one embodiment, the compositor 230 may resize the plurality of contents a1, b1, and c1 received from the plurality of first display devices A, B, and C (serving as source devices) to generate a target rectangle accordingly, and then generate a combined image in desired layout with selected effects. In another embodiment, if the electronic apparatus 200/300 is connected with the second display device(s) via a HDMI cable, a MHL cable, the compositor 230 may directly output the combined image frame by frame to the second display devices. In still another embodiment, if the electronic apparatus 200/300 is connected with the second display device(s) via a wireless display protocol (such as, a Miracast connection, a Wi-Di connection, or a Wi-Mo connection etc. Wi-Fi display connections), the compositor 230 may need to encode the combined image and package it based on the protocol definition.

Please also note that, images and audio streams may be composed and mixed simultaneously, wherein the compositor 230 is used for composing the images while the mixer 350 is used for mixing the audio streams. There can be various types of audio mixing policies. For example, in one embodiment, only one audio stream is allowed to be playback while others are muted; or in another embodiment, all the audio streams can be simply mixed to generate the mixed audio stream.

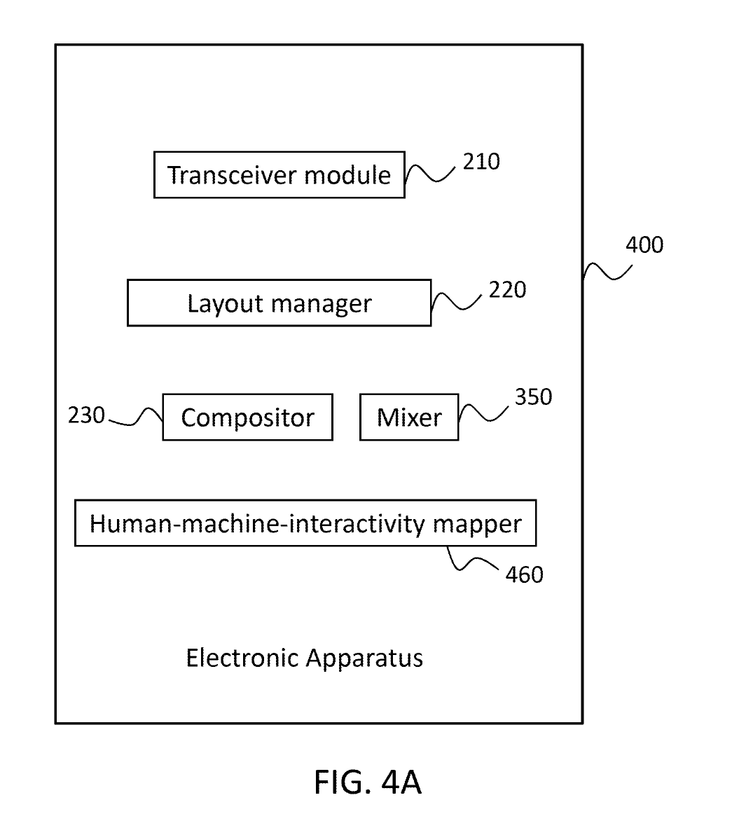

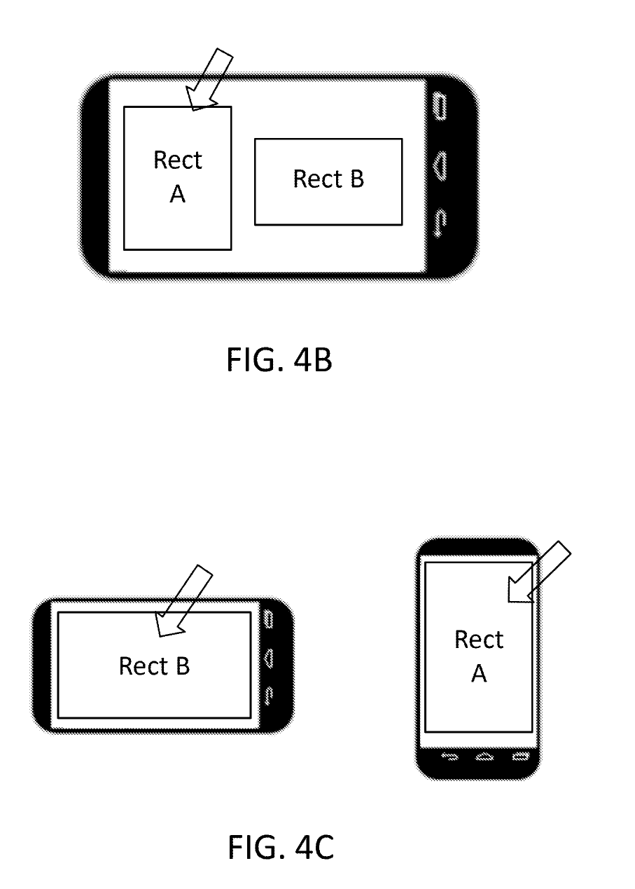

Please refer to FIG. 4A together with FIG. 1 and FIG. 3. FIG. 4A is a block diagram illustrating an electronic apparatus 400 capable of communicating with a plurality of first display devices and at least one second display device according to a third embodiment of the present invention. The electronic apparatus 400 shown in FIG. 4A is similar to the electronic apparatus 300 shown in FIG. 3, and the difference between them is that: the electronic apparatus 400 further includes a human-machine-interactivity mapper 460 for allowing user interaction from the at least one connected console device. In this embodiment, there should also be separate layout management utility (not shown) available in the connected console device to allow the connected console device to view and modify the layout information, accordingly. The connected console device is a device that is coupled to and communicates with any one of the plurality of first display devices or the source devices. In other words, the connected console device can be one of the first display device (or the source devices) or the second display device (or the sink device) or other console device that is connected to operate the application.

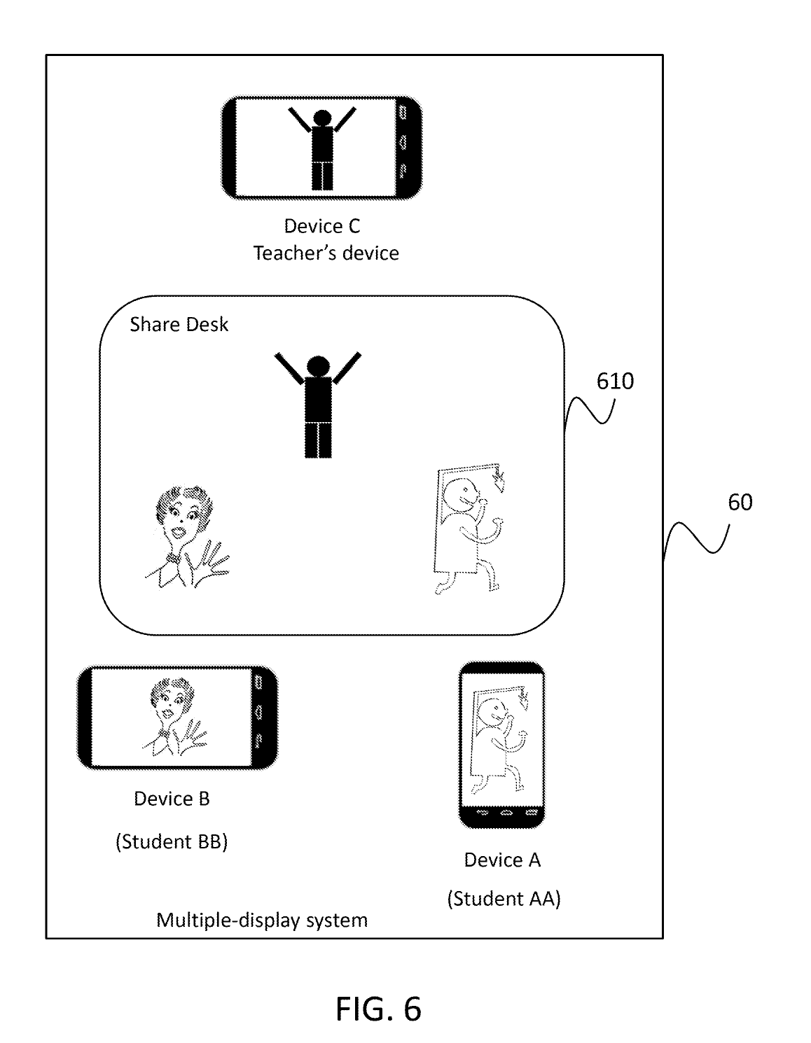

If there is a touch screen equipped in the second display device (such as, the “share desk” implementation shown in FIG. 6), one user can interact from the second display device directly. Or the user can install an application in other device and operate directly in such device to interact by using the application and here we call the device which user is using to interact with those applications as the console device. The console device can be either the second display device directly if the user is operating in the second display device or other device if user is operating from that device to interact with the application that runs in first display device and displays in second display device. In one embodiment, the console application can be used to control all the applications displayed on the second display device; in another embodiment, the application can only be used to control one of the application displayed on the second display device. However, in either situation, the application can display a UI with either a simple layout UI or even with the mirrored content(s) from the first display device to ease the user interactions.

For details, please refer to FIG. 4B and FIG. 4C. FIG. 4B is a diagram illustrating an example that in the console device, user launches the application which displays the whole layout UI relevant to the second display device and user operates in the console application to control both applications. FIG. 4C is a diagram illustrating another example that in the console device, user launches the application which displays one of the selected application layout UI relevant to the second display device and user operates in the console application to control only that selected application.

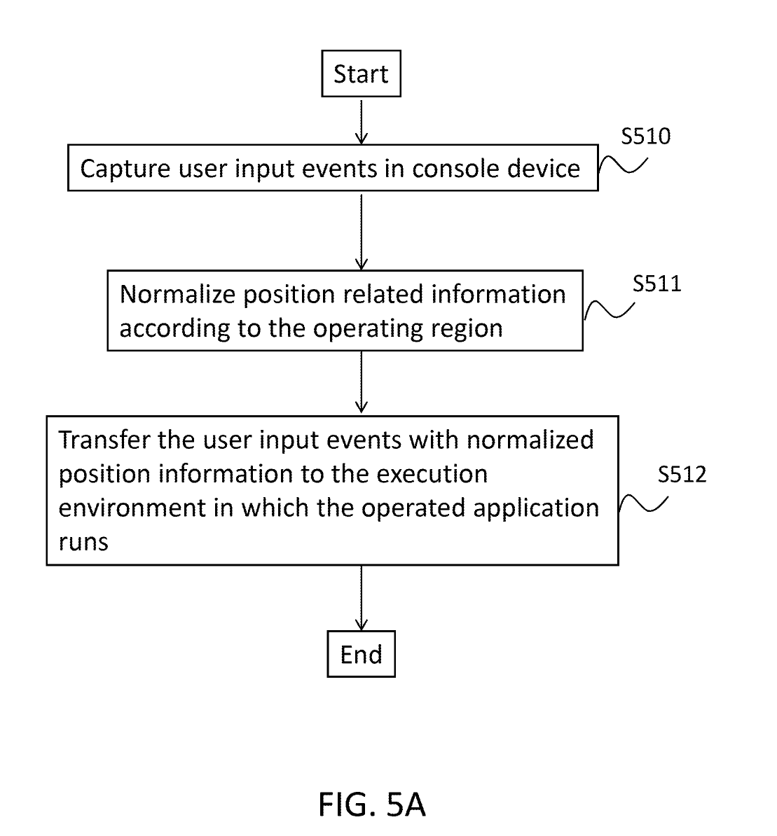

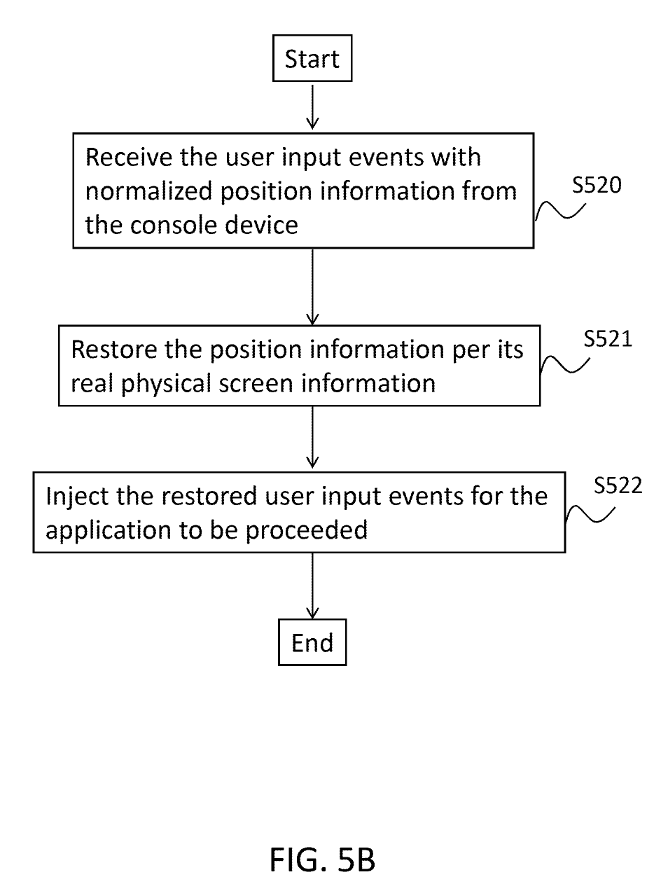

What calls for special attention is that, the human-machine-interactivity mapper 460 is arranged to map original events generated from the console device to original application execution environment in first display device side, so that such events will be accurately mapped and processed by the application execution environment. The human-machine-interactivity mapper 460 can be split into two logical components in both the console device side and the first display device side in which the operated application resides. Please refer to FIG. 5A and FIG. 5B. FIG. 5A is a flowchart regarding how user input events are caught in the console device side, normalized, and transferred to the device in which the operated application runs; while FIG. 5B is a flowchart regarding how the normalized user input events are restored and injected to real application execution environment to be proceeded.

As shown in FIG. 5A, the method includes, but is not limited to, the following steps:

Step S510: Capture user input events in console device.

Step S511: Normalize position related information according to the operating region.

Step S512: Transfer the user input events with normalized position information to the execution environment in which the operated application runs.

Please be noted that in the first display device side, the mapped operating region may only occupy a part of the whole screen, and the position normalization will need to consider such situation.

As shown in FIG. 5B, the method includes, but is not limited to, the following steps:

Step S520: Receive the user input events with normalized position information from the console device.

Step S521: Restore the position information per its real physical screen information.

Step S522: Inject the restored user input events for the application to be proceeded.

Please be noted that, the mapping between the source area and the destination area via the coordinate transformation must ensure that the touch events occurred in one area can be accurately mapped to the other area. There can be various algorithms to implement the coordinate transformation. For example, (1) a linear mapping to ensure that X coordinate (presenting a width of a rectangle) and Y coordinate (presenting a height of a rectangle) keep the same X/Width and Y/Height ratio when re-mapped between two rectangle areas; and (2) a “mirrored area” can have a convex effect, that is to say, a center of the mirrored area can be larger than the outer area so that the user can touch more accurately in the center area than the outer area.

What calls for special attention is that, the layout manager 220 mentioned in FIG. 2 is a module built inside the electronic apparatus 200, and is capable of maintaining the layout information of the at least one second display device (such as, the second display devices 110, 120, and 130) so as to generate a layout policy, wherein each of the plurality of contents (such as, streaming contents a1, b1, and c1) from the plurality of first display devices A, B, and C will occupy one rectangle. Meanwhile there should also be separate layout management utilities available in each connected device in order to allow the users to view and modify the layouts on their own devices accordingly. There can be several default layouts for various combinations. In one embodiment, various forms of a scattered 2D layout on one display without overlapping like a video wall; in another embodiment, various forms of a 2D overlapped layout with PIP effects; in still another embodiment, various forms of a 3D layout spaced with effects like a display cube or a cover-flow. In addition, there can be various layout policies to generate the combined image with the default layouts. The layout management utility may allow users to change existing default layouts. For example, a user can launch the layout management utility to get a mirrored layout on his/her screen, and then dynamically adjust the layout accordingly. By adopting the layout manager 220 inside the electronic apparatus 200/300/400, the electronic apparatus 200/300/400 can generate the streaming contents to be rendered in the at least one second display device (such as the second display devices 110, 120, and 130), and it can be used to view and change the layout simultaneously.

Please be noted that, since the content shown in second display devices or the sink devices (including the combined image) needn't to be displayed on the screen of the first display device or the source device, it can be in a separate frame buffer and transferred to the at least one second display device (such as, the second display devices 110, 120, and 130) directly. In one embodiment, the user can actually allow one application to stream the content to the second display device first, and then launch the layout management utility to view and modify the layout later.

Please refer to FIG. 6. FIG. 6 is a diagram showing a multiple-display system 60 for implementing a “Share Desk” implementation, which is a touchable desk shared by a small group of students according to another usage scenario of the present invention. As shown in FIG. 6, multiple-display system 60 is equipped with a big display screen 610 with touch capability and is able to establish multiple wireless display connections between the plurality of first display devices A, B, and C. The display screen 610 can accept broadcasted contents from a teacher via the device C; meanwhile it can also accept a plurality of contents from students via the devices A and B. Each user (such as, the teacher or the students) is able to extend the application UI in his/her own device to the display screen 610. In one embodiment, the students can use the desk's interactive capabilities to layout different contents from different sources and operate the application from each source. For example, they can look into details of references provided by the presentation the teacher is providing via the device C; they can share their homework inside their own mobile devices to each other; or they can play game (which actually runs in one of the devices A and B) on the desk display screen 610. Usually, the plurality of devices A, B, and C may be equipped with camera(s) and microphone(s), and the camera(s) and microphone(s) of the devices A, B, and C can be used when answering questions or certain student is doing presentation, while the images can be broadcast to the desk display screen.

Please refer to FIG. 7. FIG. 7 (including sub-diagrams 7A and 7B) is a diagram illustrating a condition how the electronic apparatus acted like if a dongle able to support only one first display device connection according to a first embodiment of the present invention. As shown in FIG. 7A, one part of the electronic apparatus 200/300/400 may be integrated into a mobile phone or a tablet PC (such as the first display device B, also called as a master device); while another part of the electronic apparatus 200/300/400 may be implemented by a separate smart dongle, or is integrated into a smart TV or a set-top box. Under such a condition, one first connection is built between one of the plurality of first display devices (first display device A) and the master device (device B). Here the first connection may include a Miracast connection, a Wi-Di connection, or a Wi-Mo connection etc. Wi-Fi display connections. Be noted that, the master device B will serve as one sink device and allow the first display device A to connect with it. Upon receiving the image a1 from the first display device A, the master device B will compose the image a1 from the first display device A and the image b1 from the master device B itself to generate a combined image. After that, the master device B will serve as a source device to connect with the dongle, then to the second display device 110 and transmit the combined image C to be rendered in the second display device 110 accordingly. In this embodiment, the functions of the layout manager 220, the compositor 230, and the mixer 350 are implemented and handled by the master device B. The human-machine-interactivity mapper 460 will still be split into the console device and the real device side in which the operated application runs.

FIG. 7B is a flowchart in the master side to serve as both source device side and the sink device side. And as the source device, it will generate the combined image (as well as the mixed audio stream if it exists). The method shown in FIG. 7B includes, but is not limited to, the following steps:

Step S710: The master device B serves as the sink device to receive contents from the first display device A.

Step S711: The master device B composes the images of the plurality of contents (including the content a1 from device A and the content b1 from the master device B itself) so as to generate a combined image according to a layout policy.

Step S712: The master device B mixes audio streams of the plurality of contents (including the content a1 from device A and the content b1 from the master device B itself) so as to generate a mixed audio stream according to an audio mixing policy.

Step S713: The master device B generates the source side A/V stream per dongle side connection requirement (such as, the Wi-Fi display protocol).

Step S714: The master device B serves as the source device to deliver the generated A/V stream to dongle.

Please refer to FIG. 8. FIG. 8 (including sub-diagrams 8A and 8B) is a diagram illustrating another condition that if the dongle is able to support multiple first display devices connections according to a second embodiment of the present invention. As shown in FIG. 8A, the electronic apparatus 200/300/400 may be implemented by a separate smart dongle, or is integrated into a smart TV or a set-top box. Under such a condition, a plurality of first connections are built between the transceiver module (not shown) of the electronic apparatus and the plurality of first display devices (i.e., the first display devices A and B), and each of the plurality of first connection may include a HDMI cable, a MHL cable, a Miracast connection, a Wi-Di connection, or a Wi-Mo connection etc. Wi-Fi display connections. Be noted that, in this embodiment, the dongle can support multiple wired or wireless displays to allow the first display device A and the first display device B to connect to it separately. After that, the dongle will compose the image a1 from the first display device A and the image b1 from the first display device B to generate a combined image, and then transmit the combined image to the second display device 110 accordingly. In this embodiment, the functions of the transceiver module 210, the layout manager 220, the compositor 230, and the mixer 350 may be implemented inside the dongle. The human-machine-interactivity mapper 460 will be split into the console device where user operates and the real first display device in which the operated application actually runs.

FIG. 8B is a flowchart in the dongle side to generate the combined image (as well as the mixed audio stream if it exists). The method shown in FIG. 8B includes, but is not limited to, the following steps:

Step S810: The dongle side exposes multiple sink device interfaces and receives the images of the plurality of contents from the first display device A and the first display device B.

Step S811: The dongle side composes the images of the plurality of contents (including the content a1 from device A and the content b1 from the first display device B) so as to generate a combined image according to a layout policy.

Step S812: The dongle side mixes audio streams of the plurality of contents (including the content a1 from first display device A and the content b1 from the first display device B) so as to generate a mixed audio stream according to an audio mixing policy.

Step S813: The A/V stream is transmitted from the dongle to the second display device 110.

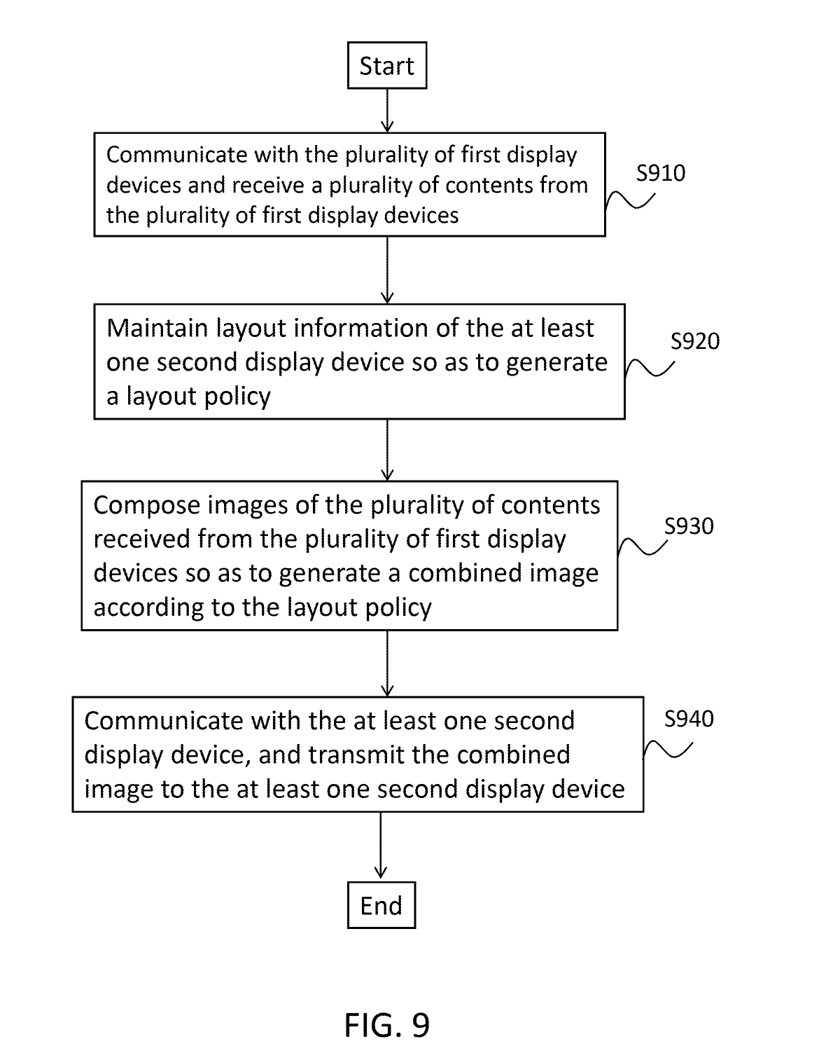

Please refer to FIG. 9. FIG. 9 is a flowchart illustrating a method, applied to an electronic device, for communicating an electronic apparatus with a plurality of first display devices and at least one second display device according to an exemplary embodiment of the present invention. Please note that the following steps are not limited to be performed according to the exact sequence shown in FIG. 9 if a roughly identical result can be obtained. The method includes, but is not limited to, the following steps:

Step S910: Communicate with the plurality of first display devices and receive a plurality of contents from the plurality of first display devices.

Step S920: Maintain layout information of the at least one second display device so as to generate a layout policy.

Step S930: Compose images of the plurality of contents received from the plurality of first display devices so as to generate a combined image according to the layout policy.

Step S940: Communicate with the at least one second display device, and transmit the combined image to the at least one second display device.

Those skilled in the art can readily understand how each element operates by combining the steps shown in FIG. 9 and the elements shown in FIG. 1 and FIG. 2, and further description is omitted here for brevity. In one embodiment, the step S910 is executed by the transceiver module 210, the step S920 is executed by the layout manager 220, the step S930 is executed by the compositor 230, and the step S940 is executed by the transceiver module 210.

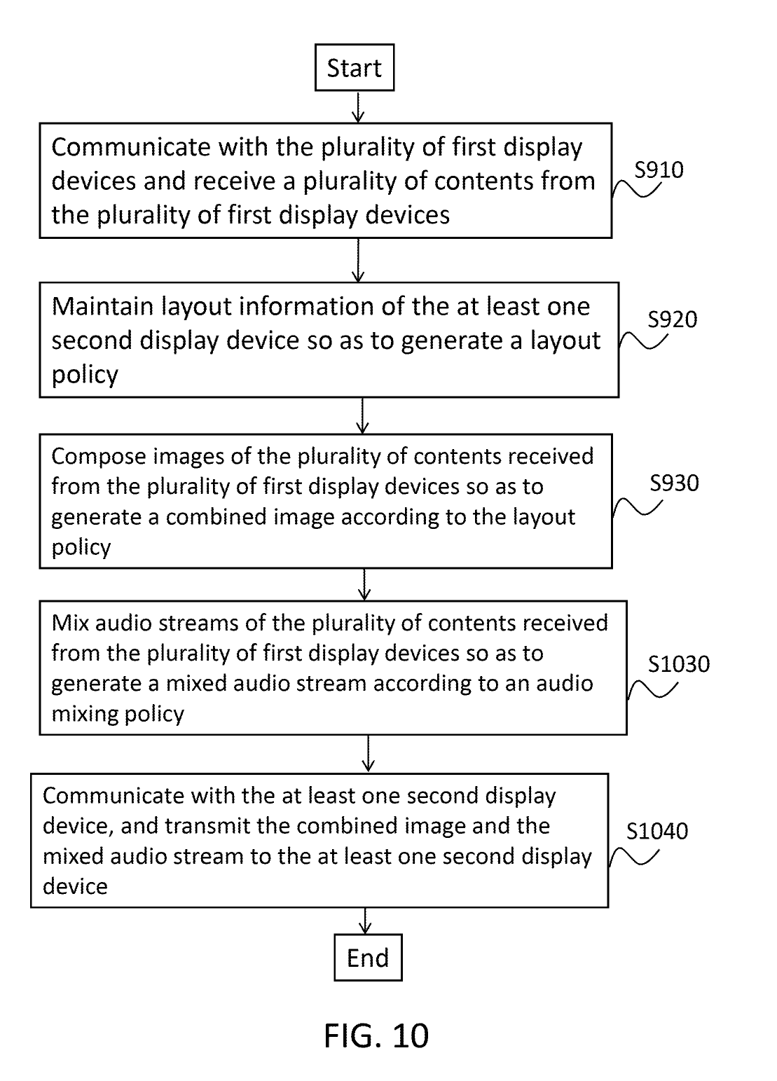

Please refer to FIG. 10. FIG. 10 is a flowchart illustrating a method, applied to an electronic device, for communicating an electronic apparatus with a plurality of first display devices and at least one second display device according to another exemplary embodiment of the present invention. Please note that the following steps are not limited to be performed according to the exact sequence shown in FIG. 10 if a roughly identical result can be obtained. The method includes, but is not limited to, the following steps:

Step S910: Communicate with the plurality of first display devices and receive a plurality of contents from the plurality of first display devices.

Step S920: Maintain layout information of the at least one second display device so as to generate a layout policy.

Step S930: Compose images of the plurality of contents received from the plurality of first display devices so as to generate a combined image according to the layout policy.

Step S1030: Mix audio streams of the plurality of contents received from the plurality of first display devices so as to generate a mixed audio stream according to an audio mixing policy.

Step S1040: Communicate with the at least one second display device, and transmit the combined image and the mixed audio stream to the at least one second display device.

Those skilled in the art can readily understand how each element operates by combining the steps shown in FIG. 10 and the elements shown in FIG. 1 and FIG. 3, and further description is omitted here for brevity. The steps shown in FIG. 10 are similar to the steps shown in FIG. 9, and the differences between them are that: (1) FIG. 10 further includes the step S1030, wherein the step S1030 is executed by the mixer 350 for mixing audio streams of the plurality of contents; and (2) FIG. 10 further transmits the mixed audio stream to the at least one second display device in the step S1040, wherein the step S1040 is executed by the transceiver module 210.

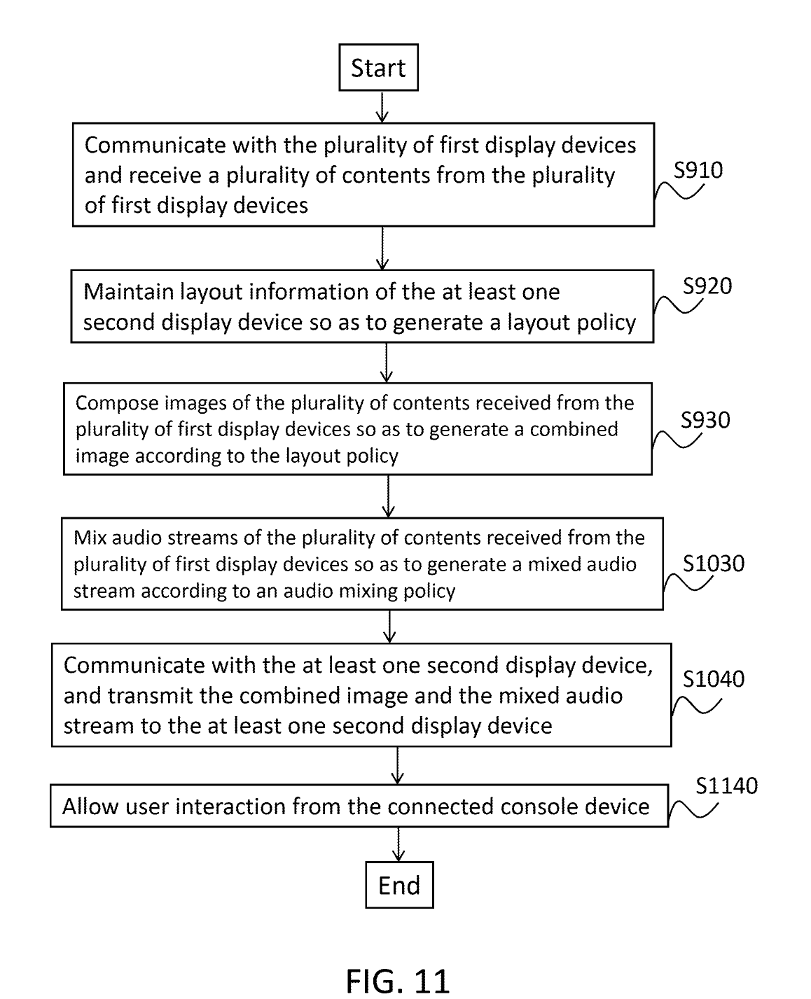

Please refer to FIG. 11. FIG. 11 is a flowchart illustrating a method, applied to an electronic device, for communicating an electronic apparatus with a plurality of first display devices and at least one second display device according to still another exemplary embodiment of the present invention. Please note that the following steps are not limited to be performed according to the exact sequence shown in FIG. 11 if a roughly identical result can be obtained. The method includes, but is not limited to, the following steps:

Step S910: Communicate with the plurality of first display devices and receive a plurality of contents from the plurality of first display devices.

Step S920: Maintain layout information of the at least one second display device so as to generate a layout policy.

Step S930: Compose images of the plurality of contents received from the plurality of first display devices so as to generate a combined image according to the layout policy.

Step S1030: Mix audio streams of the plurality of contents received from the plurality of first display devices so as to generate a mixed audio stream according to an audio mixing policy.

Step S1040: Communicate with the at least one second display device, and transmit the combined image and the mixed audio stream to the at least one second display device.

Step S1140: Allow user interaction from a connected console device.

Those skilled in the art can readily understand how each element operates by combining the steps shown in FIG. 11 and the elements shown in FIG. 1 and FIG. 4, and further description is omitted here for brevity. The steps shown in FIG. 11 are similar to the steps shown in FIG. 10, and the differences between them are that: FIG. 11 further includes the step S1140, wherein the step S1140 is executed by the human-machine-interactivity mapper 460.

The abovementioned embodiments are presented merely to illustrate practicable designs of the present invention, and should be considered to be limitations of the scope of the present invention. In summary, by adopting the method for communicating with a plurality of first display devices and at least one second display device and an electronic apparatus using the same method of the present invention, the goal of M-to-N connected usage scenario can be achieved, which can provide more convenience to users.

Those skilled in the art will readily observe that numerous modifications and alterations of the device and method may be made while retaining the teachings of the invention.

What is claimed is:

1. A method, applied to an electronic device, for communicating an electronic apparatus with a plurality of first display devices and at least one second display device, the method comprising:
communicating with the plurality of first display devices and receiving a plurality of contents from the plurality of first display devices;
maintaining layout information of the at least one second display device so as to generate a layout policy;
composing images of the plurality of contents received from the plurality of first display devices so as to generate a combined image according to the layout policy; and
communicating with the at least one second display device and transmitting the combined image to the at least one second display device.

2. The method of claim 1, further comprising:
mixing audio streams of the plurality of contents received from the plurality of first display devices so as to generate a mixed audio stream according to an audio mixing policy; and
transmitting the mixed audio stream to the at least one second display device.

3. The method of claim 2, further comprising:
allowing user interaction from a console device, wherein the console device is a device that is coupled to and communicates with any one of the plurality of first display devices; and
using a layout management utility installed on the console device for viewing and modifying the layout information.

4. The method of claim 1, wherein the plurality of contents from the plurality of first display devices comprises portrait mode images and/or landscape mode images.

5. The method of claim 1, wherein the electronic apparatus is implemented by a separate smart dongle, or is integrated into a smart TV or a set-top box.

6. The method of claim 5, further comprising:
acting the electronic apparatus like a dongle to support multiple second display devices; and
building a plurality of first connections between the dongle and the plurality of first display devices, wherein each of the plurality of first connection comprises a HDMI cable, a MHL cable, a Miracast connection, a Wi-Di connection, or a Wi-Mo connection etc. Wi-Fi display connections.

7. The method of claim 1, wherein one part of the electronic apparatus is integrated into a mobile phone or a tablet PC, while another part of the electronic apparatus is implemented by a separate smart dongle, or is integrated into a smart TV or a set-top box.

8. The method of claim 7, further comprising:
acting the electronic apparatus like a dongle to support only one second display device; and
building one first connection between one of the first display device and one of the other first display device, wherein the first connection comprises a HDMI cable, a MHL cable, a Miracast connection, a Wi-Di connection, or a Wi-Mo connection etc. Wi-Fi display connections.

9. The method of claim 1, further comprising:
building a second connection between the electronic apparatus and the at least one second display device, and the second connection comprises a HDMI cable, a MHL cable, a Miracast connection, a Wi-Di connection, or a Wi-Mo connection etc. Wi-Fi display connections.

10. An electronic apparatus capable of communicating with a plurality of first display devices and at least one second display device, comprising:
a transceiver module, arranged for communicating with the plurality of first display devices and receiving a plurality of contents from the plurality of first display devices;
a layout manager, arranged for maintaining layout information of the at least one second display device so as to generate a layout policy; and
a compositor, arranged for composing images of the plurality of contents received from the plurality of first display devices so as to generate a combined image according to the layout policy; wherein the transceiver module is further arranged for communicating with the at least one second display device and transmitting the combined image to the at least one second display device.

11. The electronic apparatus of claim 10, further comprising:
a mixer, arranged for mixing audio streams of the plurality of contents received from the plurality of first display devices so as to generate a mixed audio stream according to an audio mixing policy;
wherein the transceiver module is further arranged for transmitting the mixed audio stream to the at least one second display device.

12. The electronic apparatus of claim 11, further comprising:
a human-machine-interactivity mapper, arranged for allowing user interaction from a console device, wherein the console device is a device that is coupled to and communicates with any one of the plurality of first display devices.

13. The electronic apparatus of claim 12, further comprising:
a layout management utility, installed on the console device, for viewing and modifying the layout information.

14. The electronic apparatus of claim 10, wherein the plurality of contents from the plurality of first display devices comprises portrait mode images and/or landscape mode images.

15. The electronic apparatus of claim 10, wherein the electronic apparatus is a separate smart dongle, or is integrated into a smart TV or a set-top box.

16. The electronic apparatus of claim 15, wherein the electronic apparatus is acted like a dongle to support multiple second display devices, and a plurality of first connections are built between the dongle and the plurality of first display devices, and each of the plurality of first connection comprises a HDMI cable, a MHL cable, a Miracast connection, a Wi-Di connection, or a Wi-Mo connection etc. Wi-Fi display connections.

17. The electronic apparatus of claim 10, wherein one part of the electronic apparatus is integrated into a mobile phone or a tablet PC, while another part of the electronic apparatus is implemented by a separate smart dongle, or is integrated into a smart TV or a set-top box.

18. The electronic apparatus of claim 17, wherein the separate smart dongle is able to support only one second display device, and one first connection is built between one of the first display device and one of the other first display device, and the first connection comprises a HDMI cable, a MHL cable, a Miracast connection, a Wi-Di connection, or a Wi-Mo connection etc. Wi-Fi display connections.

19. The electronic apparatus of claim 10, wherein a second connection is built between the transceiver module and the at least one second display device, and the second connection comprises a HDMI cable, a MHL cable, a Miracast connection, a Wi-Di connection, or a Wi-Mo connection etc. Wi-Fi display connections.
